(19) United States
(12) Patent Application Publication
(10) Pub. No.: US 2026/0175115 A1
(43) Pub. Date: Jun. 25, 2026

(54) CHESS SIX

(71) Applicant: Jon L. Keener, Denver, CO (US)

(72) Inventor: Jon L. Keener, Denver, CO (US)

(21) Appl. No.: 19/000,612

(22) Filed: Dec. 23, 2024

(51) Int. Cl. A63F 3/02; A63F 3/00; A63F 11/00; A63F 13/80

(52) U.S. Cl. CPC A63F 3/02; A63F 3/00214; A63F 11/0074; A63F 13/80; A63F 2003/0022; A63F 2011/0088

(57) ABSTRACT

A board game apparatus for playing a game can include a hexagonal game board composed of eleven rows and eleven columns forming a 6×6×6 grid of hexagonal cells, two or more sets of game pieces, wherein each set of game pieces includes a group of game pieces. Each game piece has a predefined mode of movement specific to a respective game piece type, allowing players of the hexagonal board game to maneuver game pieces across the hexagonal cells to capture enemy pieces and achieve a game-winning condition. In some embodiments, the grid of hexagonal cells may be implemented a 6×6×6 grid of the hexagonal cells.

### TECHNICAL FIELD

Embodiments are related to game devices and methods of playing games. Embodiments also relate to board game devices. Embodiments further relate to a chess-like strategy board game.

### BACKGROUND

The traditional chess board is a square board with a single, flat playing surface composed of sixty-four equal-sized squares arranged in an 8×8 grid. Each square may have two alternating colors, typically black and white, providing visual contrast for players. The design of the chessboard, along with the standard rules governing the game, has remained largely unchanged for centuries. The complexity and strategic depth of chess derive from the predetermined movement patterns of its individual pieces, such as the Bishop's diagonal movement or the Knight's unique L-shaped path. These movements are restricted to a two-dimensional plane, which can be visualized as the horizontal X, Y axis of the chessboard. While this simple grid facilitates a variety of geometric patterns and strategies, it limits gameplay to a single plane, and players must develop tactics based on controlling space in this restricted format.

Three-dimensional chess is not a new concept. Raumschach, a German term meaning “space chess,” was one of the earliest known three-dimensional chess variants and was invented by Ferdinald Maack in 1907. This version features multiple levels of play, introducing an additional Z-axis to the gameplay and providing an entirely new strategic dimension. Although Raumschach has survived in some form to the present day, it remains a niche variant primarily played by enthusiasts of abstract strategy games.

Another more widely recognized three-dimensional chess variant is “Tri-Dimensional Chess,” popularized by the television series Star Trek™. In this variant, players move pieces not only across multiple levels but also adjust to varying platform sizes, further complicating the spatial strategies and adding dynamic layers to the game.

Despite the historical interest in creating chess variants that introduce a third spatial dimension, other potential innovations in chess-like games remain largely unexplored. One such unexplored concept is a chess-like game that can be played on a hexagonal board. Unlike the square grid of a traditional chessboard, a hexagonal board introduces additional movement vectors and possibilities, as each hexagonal cell has six neighboring cells compared to the four neighboring cells of a square. This geometric difference could lead to more intricate movement patterns and deeper strategic opportunities for players. Moreover, the hexagonal design opens the possibility for a more complex and engaging gameplay experience by increasing the number of movement paths and tactical considerations.

While various hexagonal board games exist, such as hexagonal checkers and other strategy games, a chess-like game leveraging the unique properties of a hexagonal board has yet to be fully implemented. Accordingly, there is a need for a novel chess-like game played on a hexagonal board, which offers players new strategic possibilities and enhances the depth of traditional chess gameplay.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide for an improved game device and a method playing a game with the game device.

It is another aspect of the embodiments to provide methods, systems and devices for an improved chess-like strategy board game.

It is a further aspect of the embodiments to provide methods, systems and devices for a board game apparatus comprising a 6×6×6 hexagonal board game.

The aforementioned aspects and other objectives and advantages can now be achieved as described herein.

In an embodiment, a board game apparatus for playing a game, can include a hexagonal game board comprising eleven rows and eleven columns forming a 6×6×6 grid of hexagonal cells, and at least two sets of game pieces, wherein each set of game pieces among the at least two sets of game pieces comprises a plurality of game pieces. Each game piece among the each set of game pieces can have a predefined mode of movement specific to a respective game piece type, allowing players of the hexagonal board game to maneuver game pieces across the hexagonal cells to capture enemy pieces and achieve a game-winning condition.

In an embodiment, the grid of hexagonal cells can comprise a 6×6×6 grid of the hexagonal cells.

In an embodiment, the plurality of game pieces of each set of game pieces can comprise the following game pieces: one King piece, one Queen piece, two Bishop pieces, two Knight pieces, two Rook pieces, and nine Pawn pieces.

In an embodiment of the board game apparatus, an objective of the game can involve placing a King piece of an opponent in the game in a game-winning condition, wherein the King piece is under a threat of capture and no legal move can reduce the threat.

In an embodiment of the board game apparatus, the King piece can be permitted to move one hexagonal cell among the grid of hexagonal cells in any of 12 directions: left, left diagonal up, left adjacent up, up, right adjacent up, right diagonal up, right, right diagonal down, right adjacent down, down, left adjacent down, and left diagonal down to an adjacent cell among the grid of hexagonal cells and either capture any enemy piece in the game occupying a destination cell, or move to an empty destination cell.

In an embodiment of the board game apparatus, King piece can be permitted to move two spaces sideways from a starting space toward a starting place of a selected Rook piece among the two Rook pieces and wherein the selected Rook piece is placed on a space skipped by the King piece.

In an embodiment of the board game apparatus, the Queen piece can be permitted to move any number of the hexagonal cells in any of 12 directions: left, left diagonal up, left adjacent up, up, right adjacent up, right diagonal up, right, right diagonal down, right adjacent down, down, left adjacent down, and left diagonal down along a continuous line of cells and capture any enemy piece in the game occupying a destination cell, or move to an empty destination cell among the hexagonal cells.

In an embodiment of the board game apparatus, a Bishop piece among the two Bishop pieces can be permitted to move any number of the hexagonal cells in any of 6 diagonal directions: left diagonal up, up, right diagonal up, right diagonal down, down, and left diagonal down along a continuous line of cells and capture any enemy piece in the game occupying a destination cell or move to an empty destination cell among the hexagonal cells.

In an embodiment of the board game apparatus, a Knight piece among the two Knight pieces can be permitted to move to any of the nearest hexagonal cells among the hexagonal cells that are not on the same row, column, or diagonal, forming an “L” shape, to capture any enemy piece occupying a destination cell, or move to an empty destination cell among the hexagonal cells.

In an embodiment of the board game apparatus, a Rook piece among the two Rook pieces can be permitted to move any number of the hexagonal cells in any of 6 adjacent directions: left, left adjacent up, right adjacent up, right, right adjacent down, and left adjacent down along a continuous line of cells, and capture any enemy piece occupying a destination cell, or move to an empty destination cell among the hexagonal cells.

In an embodiment of the board game apparatus, a Pawn piece among the nine Pawn pieces can be permitted to move forward to an adjacent unoccupied hexagonal cell among the hexagonal cells or capture an enemy piece in the game by moving to an adjacent hexagonal cell among the hexagonal cells diagonally in front, including an option for an initial two-cell move forward among the hexagonal cells, and subject to a promotion in the game to any piece, except a King piece, upon reaching a home row of an opponent in the game.

In an embodiment of the board game apparatus, the Queen piece and a Bishop piece among the two Bishop pieces can start the game with a Capture Immunity, which signifies that the Queen piece and the Bishop piece cannot be captured until at least one of the following conditions occurs: a player in the game uses a game turn to expressly disable the Capture Immunity of one game piece of an opponent; a movement of the Queen piece or the Bishop piece having Capture Immunity causes the Queen piece or the Bishop piece to lose the Capture Immunity; when a game piece is moved between a Queen pair or a Bishop pair, both Queens of the Queen pair or both Bishops of the Bishop pair lose existing Capture Immunity; or when a game piece having Capture Immunity is no longer under a threat of capture, the game piece loses Capture Immunity.

In an embodiment of the board game apparatus, the game can end in a draw under at least one of the following conditions: a player of the game has no legal move, and a King piece of the player is not in check, resulting in a stalemate; both players of the game agree to a draw; or fifty moves by each player of the game transpire without any captures or Pawn moves.

In an embodiment, a board game apparatus for playing a game, can include: a hexagonal game board comprising eleven rows and eleven columns forming a 6×6×6 grid of hexagonal cells; at least two sets of game pieces, wherein each set of game pieces among the at least two sets of game pieces comprises a plurality of game pieces; wherein each game piece among the each set of game pieces has a predefined mode of movement specific to a respective game piece type, allowing players of the hexagonal board game to maneuver game pieces across the hexagonal cells to capture enemy pieces and achieve a game-winning condition, wherein the grid of hexagonal cells comprises a 6×6×6 grid of the hexagonal cells, and wherein the plurality of game pieces of each set of game pieces comprises the following game pieces: one King piece, one Queen piece, two Bishop pieces, two Knight pieces, two Rook pieces, and nine Pawn pieces.

In an embodiment, a method for playing a board game using a board game apparatus, can involve: providing a hexagonal game board comprising eleven rows and eleven columns forming a 6×6×6 grid of hexagonal cells; providing at least two sets of game pieces, each set comprising a plurality of game pieces; assigning a predefined mode of movement to each game piece within each set of game pieces, wherein the predefined mode of movement is specific to a respective game piece type; and maneuvering the game pieces across the hexagonal cells in accordance with the predefined mode of movement to capture opposing game pieces and achieve a game-winning condition.

In an embodiment of the method, the grid of hexagonal cells can comprise a 6×6×6 grid of the hexagonal cells.

In an embodiment of the method, the plurality of game pieces of each set of game pieces can comprise the following game pieces: one King piece, one Queen piece, two Bishop pieces, two Knight pieces, two Rook pieces, and nine Pawn pieces.

In an embodiment of the method, an objective of the game can involve placing a King piece of an opponent in the game in a game-winning condition, wherein the King piece is under a threat of capture and no legal move can reduce the threat.

In an embodiment of the method, the King piece can be permitted to move one hexagonal cell among the grid of hexagonal cells in any of 12 directions: left, left diagonal up, left adjacent up, up, right adjacent up, right diagonal up, right, right diagonal down, right adjacent down, down, left adjacent down, and left diagonal down to an adjacent cell among the grid of hexagonal cells and either capture any enemy piece in the game occupying a destination cell, or move to an empty destination cell.

In an embodiment of the method, the King piece can be permitted to move two spaces sideways from a starting space toward a starting place of a selected Rook piece among the two Rook pieces and wherein the selected Rook piece is placed on a space skipped by the King piece.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a block diagram of a board game apparatus, in accordance with an embodiment;

FIG. 2 illustrates a block diagram depicting distinct movement rules with respect to game pieces, in accordance with an embodiment;

FIG. 3 illustrates a block diagram depicting additional features of the board game apparatus, in accordance with an embodiment;

FIG. 4 illustrates a flow diagram depicting logical operational steps of a method for implementing a board game apparatus, in accordance with an embodiment;

FIG. 5 illustrates a schematic diagram depicting a starting arrangement of 34 ChesSix men in a board game apparatus, in accordance with an embodiment;

FIG. 6 illustrates a schematic diagram of the board game apparatus, wherein the Rook (R) may move along any straight line of contiguous unobstructed hexagons in any of 6 directions, in accordance with an embodiment;

FIG. 7 illustrates a schematic diagram of the board game apparatus, wherein the Bishop (B) may move along any straight line of diagonal unobstructed hexagons in any of six directions, in accordance with an embodiment;

FIG. 8 illustrates a schematic diagram of the board game apparatus, wherein the Queen (Q) may move along any straight line of contiguous or non-contiguous unobstructed hexagons in any of 12 directions, in accordance with an embodiment;

FIG. 9 illustrates a schematic diagram of the board game apparatus, wherein the Knight (N) can make a “crooked” move, and may jump over obstructions to reach its destination, in accordance with an embodiment;

FIG. 10 illustrates a schematic diagram of the board game apparatus, wherein the King (K) can one space in any direction, contiguously or diagonally, in accordance with an embodiment;

FIG. 11 illustrates a schematic diagram of the board game apparatus, wherein the two Pawns can capture each other, in accordance with an embodiment;

FIG. 12A illustrates a schematic diagram of the board game apparatus with the initial position of Kings and Rooks, in accordance with an embodiment;

FIG. 12B illustrates a schematic diagram of the board game apparatus with the positions after White Castling King-side, in accordance with an embodiment;

FIG. 12C illustrates a schematic diagram of the board game apparatus with the positions after White Castling Queen-side, in accordance with an embodiment;

FIG. 13 illustrates a schematic diagram depicting the possible movement in a game facilitated by the board game apparatus, in accordance with an embodiment;

FIG. 14 illustrates a schematic view of a computer system, in accordance with an embodiment;

FIG. 15 illustrates a schematic view of a software system including a module, an operating system, and a user interface, in accordance with an embodiment;

It is important to note that while the drawings and figures presented herein are illustrated in black and white, they might have originally been created and displayed in color. As a result, those skilled in the art will understand that even though the images and figures may not display color, they may actually depict features in color.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Furthermore, the term “at least one” as utilized herein can refer to “one or more”. For example, “at least one widget” may refer to “one or more widgets.”

The term “board game” as utilized herein can relate to a physical board game and/or an electronic board game that may be graphically displayed in the context of a graphical user interface (GUI). That is, the term “board game” can encompass a broad spectrum of game formats, including both physical and digital embodiments. In the physical sense, “board game” can relate to a tangible, physical game apparatus that can involve a playing board, game pieces, cards, dice, or other components utilized in traditional board game play.

In the electronic or digital context, however, “board game” may extend to any digital or virtual representation of a board game. This virtual version can be displayed through a GUI on various electronic devices, such as computers, tablets, smartphones, or dedicated gaming consoles. The graphical display may visually mimic the layout, components, and interactive elements of the physical version or introduce unique digital enhancements, animations, or user controls that augment the gameplay experience. Accordingly, this definition of “board game” allows for flexibility in implementation across both traditional physical formats and modern electronic or virtual environments.

The embodiments described herein pertain to various game devices and methods of playing games, covering a wide range of game types and interactive formats. These embodiments include both physical and electronic implementations, designed to enhance user engagement through innovative gameplay mechanics, user interfaces, and strategically designed components. Additionally, embodiments relate specifically to board game devices, which may include traditional physical board games as well as digital adaptations designed for use on electronic platforms. These board game devices can incorporate distinct features, such as unique game boards, pieces, and rulesets, that contribute to a diverse and dynamic gaming experience.

Furthermore, embodiments extend to a particular category of board games characterized as chess-like strategy games. Such games involve strategic decision-making and tactical maneuvers, often relying on game mechanics that are inspired by or akin to chess. These chess-like strategy games may include game boards with grid-based layouts and a variety of distinct playing pieces, each with its own movement capabilities, objectives, and roles within the game. These games may be designed to encourage strategic planning, problem-solving, and competitive play, appealing to players who enjoy depth and complexity in game design. The embodiments, therefore, address both the structure of the game devices and the methods of play, providing a comprehensive framework for game interaction that can appeal to a broad audience of players.

Embodiments are also related to a hexagonal board game apparatus and a method of playing the hexagonal board game. The hexagonal board game apparatus is designed for strategic gameplay on a hexagonal game board. The hexagonal board game apparatus can include a hexagonal board arranged in an eleven-row by eleven-column configuration, thereby creating a 6×6×6 grid of hexagonal cells. The game can be played with at least two sets of game pieces, each set comprising a variety of pieces with predefined movement types, allowing players to maneuver pieces across the board to capture opposing pieces and attain victory conditions.

Game pieces can include specific types such as, for example, Kings, Queens, Bishops, Knights, Rooks, and Pawns, each possessing unique movement abilities. Game rules can further provide for special conditions, including Capture Immunity for certain pieces and defined scenarios for game outcomes, such as victory, draw, or stalemate. Additionally, a method of gameplay is outlined, describing the arrangement of the game board, the movement rules for each piece type, and the sequence for achieving game objectives.

Note that the term “board game apparatus” as utilized here can relate not only to a physical and/or electronic/virtual board game device but also to the game itself, which can be played or facilitated via the board game apparatus. The term “board game apparatus,” as used herein, can convey a flexible and inclusive concept that applies to multiple facets of a board game experience. This term can encompass not only the physical board game device itself—such as the board, pieces, dice, cards, or other tangible components involved in traditional board game play—but also extends to digital or electronic versions of the game that may be displayed and interacted with through a computer, tablet, smartphone, or similar device.

Furthermore, “board game apparatus” may relate to the game's entire framework, including the specific rules, objectives, and play mechanics that define the gameplay experience. In this sense, the term “board game apparatus” captures the game as a whole, whether as a physical or virtual entity, enabling it to be played, facilitated, and enjoyed in various formats. This can include, for instance, implementations where the board game apparatus is configured to support either individual play, multiplayer interactions, or even remote play, allowing users to engage with the game across different platforms or locations.

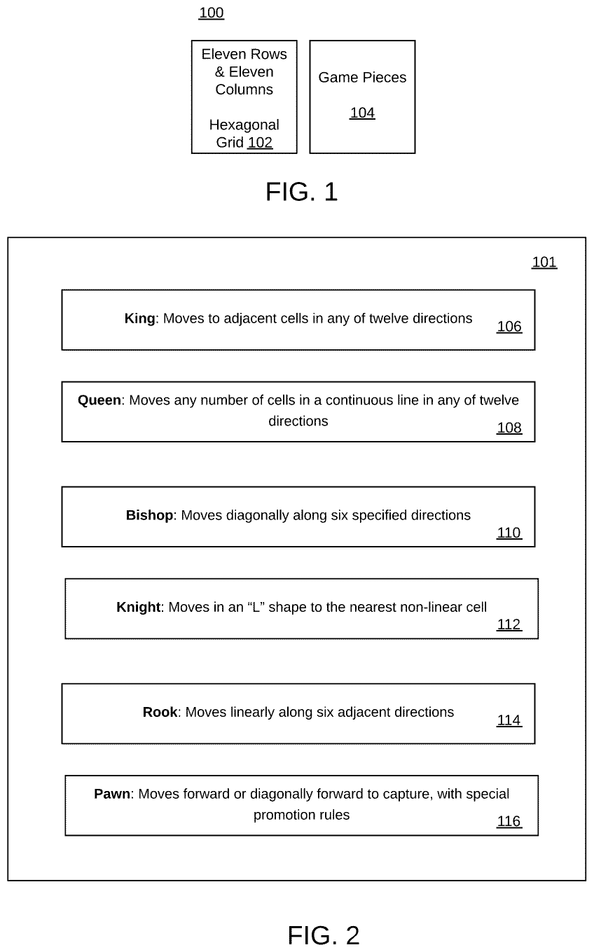

FIG. 1 illustrates a block diagram of a board game apparatus 100, in accordance with an embodiment. The board game apparatus 100 described herein can be referred to as “ChesSix” and can be implemented in the context of a hexagonal game board, which can be structured in eleven rows and eleven columns, forming a 6×6×6 grid of hexagonal cells, as indicated at block 102. The board game apparatus 100 can further include two or more sets of game pieces, as shown at block 104, with each set containing multiple pieces of various types.

In addition, each piece can be assigned with a unique mode of movement specific to its type, allowing players to maneuver pieces across the board's hexagonal cells, capture opposing pieces, and reach a game-winning condition. Each game piece can be selected from a set comprising, for example, one King, one Queen, two Bishops, two Knights, two Rooks, and nine Pawns. An objective of the board game apparatus can involve positioning an opponent's King in an inescapable capture position, defined as a game-winning condition.

FIG. 2 illustrates a block diagram depicting distinct movement rules 101 with respect to game pieces, in accordance with an embodiment, and which can be used to implement the board game apparatus 100 shown in FIG. 1. Each piece can follow distinct movement rules as noted below with respect to the blocks shown in FIG. 1:
Block 106—King: Moves to adjacent cells in any of twelve directions.
Block 108—Queen: Moves any number of cells in a continuous line in any of twelve directions.
Block 110—Bishop: Moves diagonally along six specified directions.
Block 112—Knight: Moves in an “L” shape to the nearest non-linear cell.
Block 114—Rook: Moves linearly along six adjacent directions.
Block 116—Pawn: Moves forward or diagonally forward to capture, with special promotion rules.

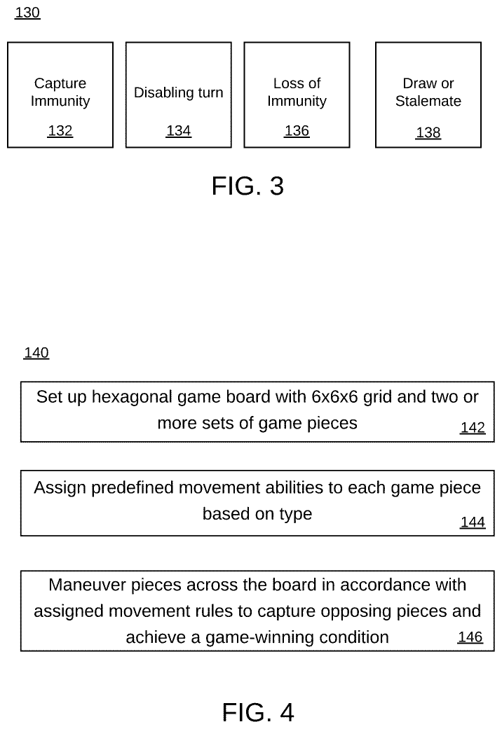

FIG. 3 illustrates a block diagram depicting additional features of the board game apparatus 100 shown in FIG. 1, in accordance with an embodiment. The board game apparatus 100 can include a Capture Immunity feature as shown at block 132 for certain pieces, such as the Queen and Bishops, whereby the pieces cannot be captured until specified conditions occur. The board game apparatus 100 also can include a disabling turn as indicated at block 136 or a loss of immunity as shown at block 138 upon movement or specific arrangement on the board. The game can end in a draw under conditions such as mutual player agreement or if fifty moves transpire without a capture or a Pawn move, or by stalemate if a player has no legal moves with their King not in check, as indicated at block 138.

FIG. 4 illustrates a flow diagram depicting logical operational steps of a method 140 for implementing and/or facilitating the board game apparatus 100, in accordance with an embodiment. As shown at block 142, a step or operation can be implemented to set up a hexagonal game board with a 6×6×6 grid and at least two sets of game pieces. As indicated next at block 144, a step or operation can be implemented to assign predefined movement abilities to each game piece based on type. Then, as shown at block 146, a step or operation can be implemented to maneuver pieces across the game board in accordance with assigned movement rules to capture opposing pieces and achieve a game-winning condition.

An object of the board game apparatus 100 (ChesSix) is to force a position, called “checkmate”, in which the enemy King is subject to capture and there is no escape. In an example scenario, white has the first move and will begin with either a Pawn or a Knight. The moves of the ChesSix men are explained below, along with a special move called “castling”. Except for castling, a player's move may involve the transfer of one of his or her men to another hexagon, possibly capturing any enemy piece which may occupy that hexagon (an exception for the Pawn is explained below).

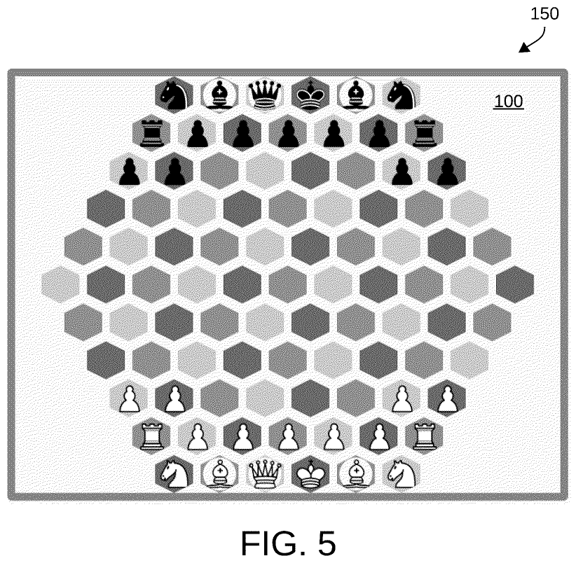

The board game apparatus 100 can be implemented in the context of a 6×6×6 hexagonal gameboard and two sets of ChesSix men, white and black, numbering 1 King (K), 1 Queen (Q), 2 Bishops (B), 2 Knights (N), 2 Rooks (R) and 9 Pawns (P), for a total of 17 men per side. The starting arrangement of the 34 ChesSix men is depicted in FIG. 5.

FIG. 5 illustrates a schematic diagram 150 depicting a starting arrangement of thirty-four ChesSix men in the board game apparatus 100, in accordance with an embodiment. In the example arrangement as shown in FIG. 5, the ChesSix men can be strategically positioned across a hexagonal board layout to facilitate gameplay that emphasizes strategic maneuvering and capture. The board game apparatus 100 features a pattern of interconnected hexagonal spaces, allowing for six directions of movement.

Each player's men can be arranged in a symmetrical and balanced formation at the beginning, designed to enhance strategic depth and provide equal opportunities for offensive and defensive positioning. The thirty-four pieces can include traditional roles, such as Rook, Knight, and Bishop, but are adapted to suit the six-directional movement paradigm of a hexagonal grid. This layout can allow each player to quickly engage in various tactical moves, with the opening arrangement optimized to encourage interaction across the hexagonal board space.

The ChesSix men are traditionally referred to as “black” and “white”, regardless of the actual choice of contrasting colors. The hexagon colors are referred to as “black”, “white”, and “grey”. In the starting arrangement, the Bishops and Queens can be backlit with yellow, which can signify Capture Immunity. The Bishops and Queens can start the game with Capture Immunity, meaning that they cannot be captured until one of four things occur:
1) A player may use a turn to expressly disable the Capture Immunity on one of the opponent's pieces. This is the only turn in ChesSix wherein no pieces are moved. The Capture Immunity is removed in exchange for the player's turn.
2) Moving a Queen or Bishop that has Capture Immunity causes that piece to lose its Capture Immunity.
3) If a piece is moved between a Queen pair or a Bishop pair, both Queens or both Bishops lose any existing Capture Immunity.
4) If any piece that has Capture Immunity is no longer under threat of capture, it loses its Capture Immunity.

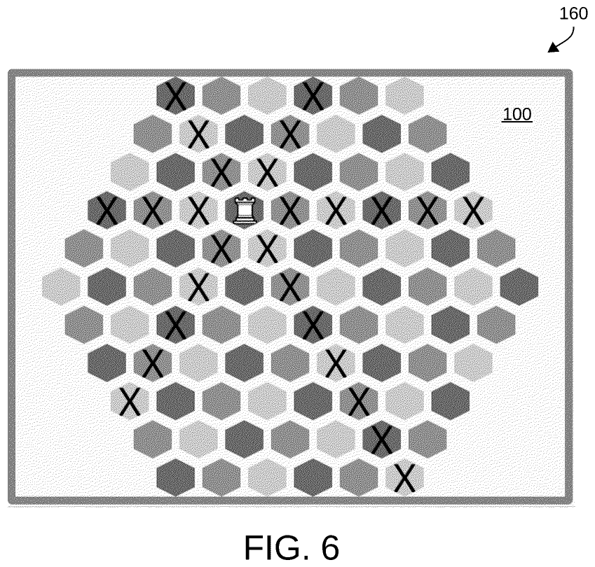

FIG. 6 illustrates a schematic diagram 160 of the board game apparatus 100, wherein the Rook (R) may move along any straight line of contiguous unobstructed hexagons in any of six directions, in accordance with an embodiment. This design can adapt the Rook movement to the hexagonal grid by leveraging the additional movement paths offered by the six-directional layout.

Unlike a standard chessboard, where movement is restricted to four cardinal directions, the hexagonal arrangement enables the Rook to traverse in three unique pairs of opposing directions, adding a layer of complexity to movement strategy. This increased range of directional possibilities enhances the Rook's potential to control larger swaths of the board, allowing it to serve as both an offensive and defensive piece with expanded reach. This adaptation may require players to reconsider traditional strategies, as the hexagonal design alters the dynamics of control and potential blockades on the board of the board game apparatus 100.

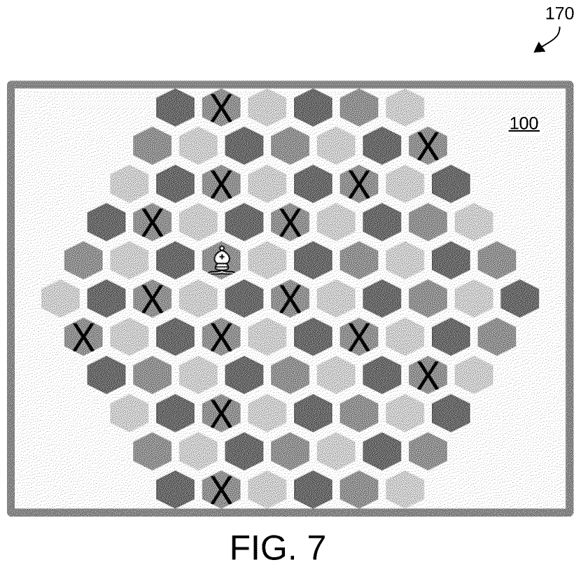

FIG. 7 illustrates a schematic diagram 170 of the board game apparatus 100, wherein the Bishop (B) may move along any straight line of diagonal unobstructed hexagons in any of six directions, in accordance with an embodiment. In this configuration, the Bishop's movement is adapted to the hexagonal grid, allowing it to traverse in diagonal paths that are unique to this board's structure. Unlike traditional square-grid chessboards, which restrict diagonal movement to four directions, the hexagonal layout offers six potential movement directions, providing the Bishop with a broader range of mobility.

Each movement path can extend uninterruptedly through a line of connected hexagonal spaces, provided no other pieces obstruct its route. This adaptation amplifies the Bishop's role as a versatile piece with increased influence over the board, enhancing its capacity to apply pressure from various angles. The six-directional diagonal movement can allow the Bishop to cover a more extensive area, making it capable of reaching deeper into the opponent's territory or establishing broader defensive networks. This setup requires players to anticipate unconventional diagonal attacks and defense lines, adding a new level of strategic complexity to gameplay on the hexagonal grid.

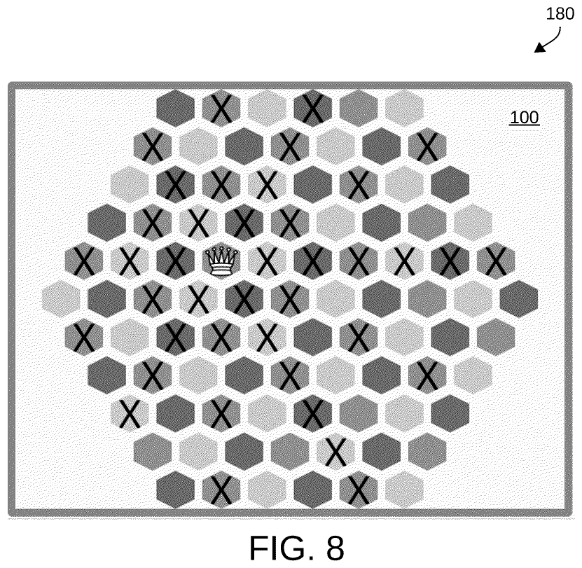

FIG. 8 illustrates a schematic diagram 180 of the board game apparatus 100, wherein the Queen (Q) may move along any straight line of contiguous or non-contiguous unobstructed hexagons in any of 12 directions, in accordance with an embodiment. The embodiment of the board game apparatus 100 depicted in FIG. 8 provides the Queen with unparalleled versatility and reach, combining the movement capabilities of both the Rook and Bishop adapted to the hexagonal board structure. Unlike the traditional square chessboard where the Queen is limited to eight directions, the hexagonal configuration introduces four additional directional paths, allowing movement along six straight lines and six diagonal lines. The Queen can maneuver through any of these paths as long as they remain unobstructed, covering extensive areas of the board and enabling the player to control the game from nearly any position.

In addition to its movement on contiguous hexagons, the Queen's unique ability to move across non-contiguous hexagons further enhances its strategic power. This feature allows the Queen to bypass obstacles, offering an alternative means to reach distant positions without being hindered by other pieces in its path. This additional flexibility elevates the Queen's role as the most dynamic and influential piece on the board, as it can seamlessly switch between offense and defense, placing pressure on the opponent from virtually any angle. The expanded range and movement options require players to think beyond conventional chess strategies, as the Queen's broader directional freedom and increased mobility on the hexagonal grid add a unique complexity to both attacking and defending strategies.

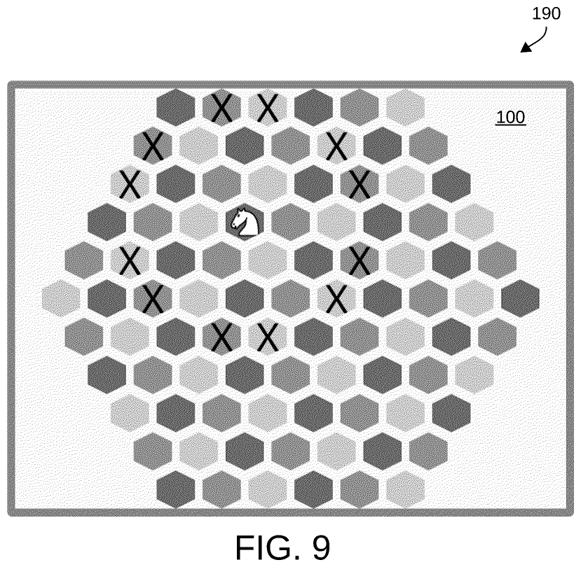

FIG. 9 illustrates a schematic diagram 190 of the board game apparatus 100, wherein the Knight (N) can make a “crooked” move, and may jump over obstructions to reach its destination, in accordance with an embodiment. The Knight (N) can make a “crooked” move, and may jump over obstructions to reach its destination, unlike the other ChesSix men discussed so far. The move may be visualized as a move along two contiguous hexagons in one direction plus a move along one additional contiguous hexagon in a new direction, as illustrated in FIG. 9.

In the embodiment depicted in FIG. 9, the Knight's movement can be adapted to the unique hexagonal layout of the board, enhancing its traditional “L-shaped” movement pattern. The term “crooked” here can relate to the Knight's ability to move in a distinctive two-step pattern that combines a single step in one direction, followed by an additional step in a different, non-linear direction. This movement can allow the Knight to navigate the hexagonal grid with flexibility, covering spaces that other pieces may not be able to reach directly.

In addition to its “crooked” movement, the Knight possesses the special ability to jump over other pieces, a trait carried over from classic chess but modified for the hexagonal configuration. This jumping ability enables the Knight to bypass obstructions in its path, making it uniquely suited for executing unexpected maneuvers, even in crowded board positions. This jump capability ensures that the Knight remains a versatile and unpredictable piece, capable of reaching targeted hexagons regardless of intervening pieces.

The Knight's movement on the hexagonal board can introduce a strategic layer where players must account for its unconventional range and sudden, hard-to-predict attacks. Unlike pieces restricted by linear movement, the Knight can position itself for attacks on critical areas without being hampered by nearby allies or foes, making it ideal for both offensive strikes and defensive setups. Its ability to leap over obstructions also gives it a tactical advantage in reaching otherwise inaccessible spaces, which can be crucial in evading threats or positioning for a check. Consequently, the Knight's “crooked” move and jump potential add a dynamic, chess-specific complexity to the game, prompting players to leverage its movement creatively within the hexagonal framework.

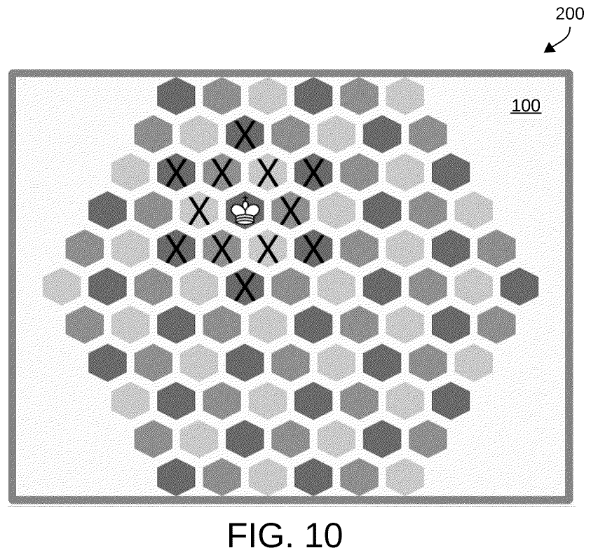

FIG. 10 illustrates a schematic diagram 200 of the board game apparatus 100, wherein the King (K) can move one space in any direction, contiguously or diagonally, in accordance with an embodiment. When the King is subject to capture, he is said to be in “check”, and the check must be parried immediately. Possible ways are:
(1) To capture the enemy threat.
(2) To move the King to a safe space.
(3) To interpose a piece into the path of a checking Queen, Rook, or Bishop

Players are not allowed by any move to expose their King to check. If a player cannot legally parry an enemy check, the King is in checkmate, and the game is over.

In this example shown in FIG. 10, the King's movement can be adapted to the hexagonal grid structure, allowing it to step to any of the six adjacent hexagons that surround it, either along a straight line or along one of the six diagonal paths. This can provide the King with more versatile movement compared to a traditional square-grid chessboard, where it can only move to eight possible adjacent squares.

The hexagonal board apparatus configuration shown in FIG. 10 allows the King to move in twelve directions, granting it additional options for both evasion and positioning. This flexibility is especially advantageous in endgame scenarios, where the King's mobility can be critical for maneuvering away from threats or supporting the advancement of other pieces. Despite this increased directional freedom, the King's movement remains restricted to one space at a time, ensuring it retains its unique role as a high-value, protected piece that must avoid direct attacks.

The King's ability to move one hexagon in any direction reflects its essential status, balancing accessibility with vulnerability. While it has the capacity to move across a wide range of directions, each move must be carefully considered to avoid exposure to potential threats from opposing pieces. This added mobility on the hexagonal board introduces new strategic opportunities, as the King can shift to safety or approach key positions without becoming confined by the orthogonal limitations of a square board. The expanded range of movement in this embodiment encourages players to think beyond traditional defense strategies, adding a fresh layer of tactical depth to gameplay on the hexagonal board.

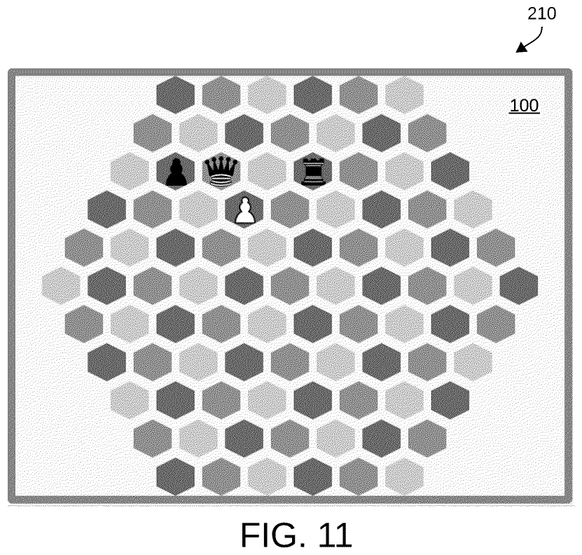

FIG. 11 illustrates a schematic diagram 210 of the board game apparatus 100, wherein the two Pawns can capture each other, in accordance with an embodiment. The Pawn (P) can advance one contiguous hexagon per move, never retreating. Optionally, a Pawn may advance two spaces on its first move. When a Pawn reaches the opponent's home row, it is immediately promoted to a piece of the player's choice, except a King.

Unlike other ChesSix men, the Pawn may not capture an enemy man by its normal move and is therefore blocked if there are men on the two contiguous hexagons immediately in front of it. However, the Pawn may capture an enemy piece on either hexagon diagonally ahead of it—the Pawn moves diagonally forward to make the capture.

In FIG. 11, the two Pawns can capture each other. It is white's turn, so the white Pawn may choose between capturing the black Pawn or the black Rook, or simply advancing forward to the white space in front of it. In addition, there is no capturing “en passant” in the game of ChesSix. Pawns may only capture an enemy piece on either hexagon diagonally ahead of it.

In the embodiment depicted in FIG. 11, the Pawns have been adapted for play on the hexagonal grid, allowing them to perform captures in directions that align with the hexagonal structure. Unlike traditional chess, where Pawns capture diagonally on a square board, the hexagonal layout introduces new directional possibilities for capture. Each Pawn can move forward and capture on adjacent diagonal hexagons within its movement range, expanding its offensive capabilities to align with the six-directional possibilities of the hexagonal design.

This design not only enhances the Pawn's role on the board but also increases the complexity of their interactions. The capture mechanism allows Pawns to challenge each other from varied angles, creating fresh opportunities for tactical play and positioning. When two opposing Pawns are placed within capture range of each other, as illustrated in FIG. 11, a standoff occurs where each Pawn has the potential to eliminate the other, adding tension and strategic depth. Players must now consider the possibility of multi-directional captures when advancing or positioning Pawns, as the hexagonal board makes it possible for Pawns to be captured from angles not available on a traditional square board.

This embodiment also adds flexibility to the Pawn's overall movement and capturing potential, making it a more dynamic piece than in conventional chess. Players can leverage this expanded capture capability to support defensive strategies, control key hexagons, or advance into the opponent's territory with greater adaptability. The possibility for mutual capture between two Pawns encourages players to be highly strategic about their positioning, as an unguarded Pawn can now face threats from unexpected directions on the hexagonal board. This adaptation ultimately redefines the Pawn's role, making it a more versatile and tactically significant piece within the context of the hexagonal game structure.

Note that “castling” is a special move, normally done with the intention of protecting the King and developing the Rook for action: The mechanics of ChesSix castling are:
(1) Move the King two spaces sideways from its starting space toward the chosen Rook's starting space, and
(2) Place the castled Rook on the space skipped over by the King.

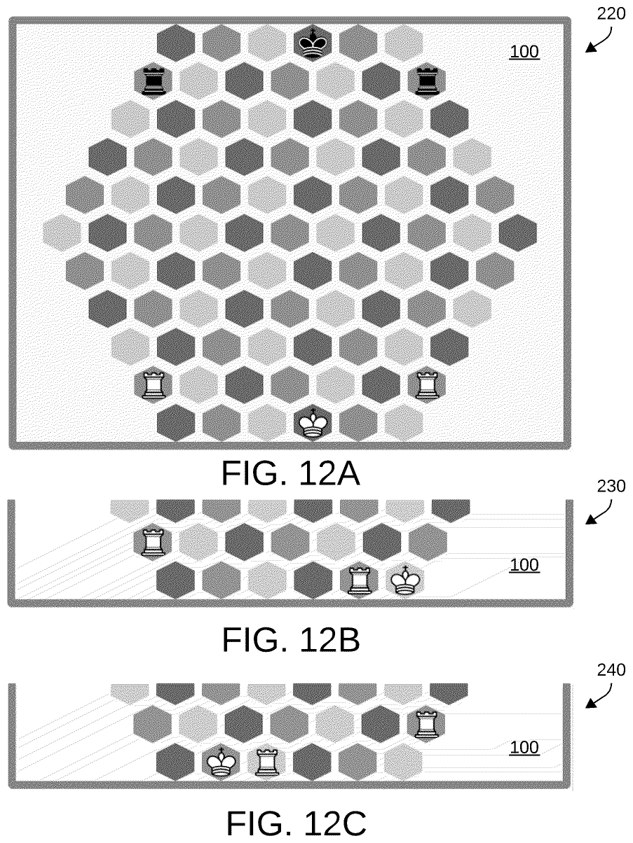

FIG. 12A illustrates a schematic diagram 220 of the board game apparatus 100 with the initial position of Kings and Rooks, in accordance with an embodiment. In this starting configuration, each King is placed in a protected position near the rear of each player's side, guarded by other pieces, while each Rook is positioned strategically to leverage its full range of movement along the hexagonal grid. The Rook's ability to move in six straight directions enables it to quickly establish control over key areas of the board, supporting both defensive and offensive play. This layout provides a balanced setup where the King is secured yet accessible for strategic maneuvering, and the Rooks are primed to influence multiple pathways from the outset, creating an engaging opening that encourages players to carefully consider early-game positioning and protection on the hexagonal board.

FIG. 12B illustrates a schematic diagram 230 of the board game apparatus 100 with the positions after White Castling King-side, in accordance with an embodiment. In this configuration, the White King has shifted two spaces toward the Rook, while the Rook has moved to the immediate left of the King, effectively enhancing the King's safety by placing it behind a defensive line of pieces.

This maneuver not only serves to protect the King from potential threats but also allows the Rook to become more active, centralizing its position for greater control over the board. The castling move exemplifies strategic planning, as it facilitates quicker development of the Rook while simultaneously securing the King, thus reinforcing White's overall position. This adaptation of the castling mechanism to the hexagonal layout can add a layer of complexity, as players must navigate the unique movement rules of the hexagonal grid while considering the implications of this vital defensive tactic.

FIG. 12C illustrates a schematic diagram 240 of the board game apparatus 100 with the positions after White Castling Queen-side, in accordance with an embodiment. In the configuration shown in FIG. 12C, the White King has moved two spaces towards the Queen-side Rook, while the Rook has been repositioned to occupy the space immediately adjacent to the King, effectively fortifying its defensive position. This strategic maneuver not only enhances the King's safety by sheltering it behind a line of protective pieces, but also activates the Rook, enabling it to participate more effectively in the game.

The Queen-side castling exemplifies a proactive approach to piece development, as it opens up lines for the Queen and other pieces while simultaneously ensuring that the King is less exposed to potential threats from the opposing side. This adaptation of the castling move to the hexagonal board adds an additional layer of strategy, as players must consider the unique movement possibilities and defensive dynamics presented by the hexagonal grid, making the decision to castle both a tactical and defensive maneuver in the evolving game landscape.

Note that a game can be ruled a draw if a player has no legal move, yet his or her King is not in check. This situation can also be referred to as a “stalemate”. A game may of course be drawn by agreement. A player may claim a draw if, on his move, the position has occurred thrice. Also, a player may claim a draw if fifty moves by each player transpire without any captures or Pawn moves.

Relative to the Pawn, the value of ChesSix pieces is roughly as follows:
Pawn . . . 1
Bishop . . . 3
Knight . . . 4
Rook . . . 5
Queen . . . 10

The value of a Bishop changes with the circumstances. Its value can be higher when it has scope or when the two Bishops can act in unison. The same is true of Rooks also.

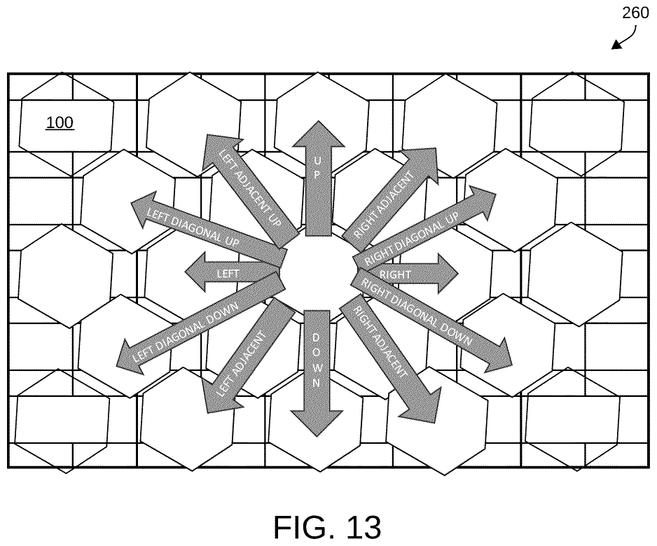

FIG. 13 illustrates a schematic diagram 260 depicting a possible movement in a game facilitated by the board game apparatus 100, in accordance with an embodiment. The configuration shown in FIG. 13 indicates a variety of possible moves including, for example, up, down, left adjacent up, left diagonal up, left, right, right adjacent, right diagonal up, left diagonal down, right diagonal down, left adjacent, or right adjacent.

As can be appreciated by one skilled in the art, some embodiments can be implemented in the context of a method, data processing system, or computer program product. Accordingly, some embodiments may take the form of an entirely hardware embodiment, an entirely software embodiment or an embodiment combining software and hardware aspects all generally referred to herein as a “circuit” or “module.”

Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object oriented programming language (e.g., Java, C++, etc.). The computer program code, however, for carrying out operations of particular embodiments may also be written in procedural programming languages or in a visually oriented programming environment.

The program code may execute entirely on a user's computer, partly on a user's computer, as a stand-alone software package, partly on a user's computer and partly on a remote computer or entirely on the remote computer. In the latter scenario, the remote computer may be connected to a user's computer through a bidirectional data communications network (e.g., a local area network (LAN), wide area network (WAN), wireless data network, a cellular network, etc.) or the bidirectional connection may be made to an external computer via most third party supported networks (e.g., through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, the disclosed embodiments can be implemented in the context of, for example a special-purpose computer or a general-purpose computer, or another programmable data processing apparatus or system. For example, in some embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

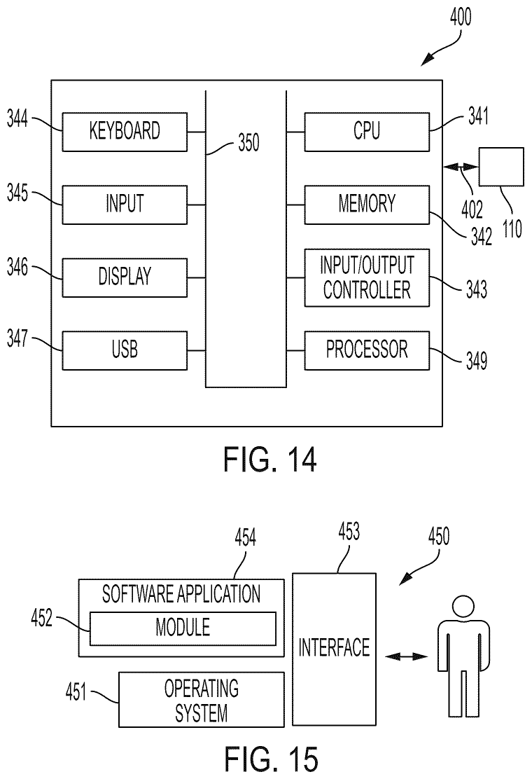

FIGS. 14-15 are shown only as exemplary diagrams of data-processing environments in which example embodiments may be implemented. It should be appreciated that FIGS. 14-15 are only exemplary and are not intended to assert or imply any limitation with regard to the environments in which aspects or embodiments may be implemented. Many modifications to the depicted environments may be made without departing from the spirit and scope of the disclosed embodiments.

As illustrated in FIG. 14, some embodiments may be implemented in the context of a data-processing system 400 that can include, for example, one or more processors including a CPU (Central Processing Unit) 341 and/or other another processor 349 (e.g., microprocessor, microcontroller etc.), a memory 342, an input/output controller 343, a peripheral USB (Universal Serial Bus) connection 347, a keyboard 344 and/or another input device 345 (e.g., a pointing device such as a mouse, trackball, pen device, etc.), a display 346 (e.g., a monitor, touch screen display, etc.) and/or other peripheral connections and components. FIG. 14 is an example of a computing device that can be adapted for use in accordance with one possible embodiment.

As illustrated, the various components of the data-processing system 400 can communicate electronically through a system bus 351 or similar architecture. The system bus 351 may be, for example, a subsystem that transfers data between, for example, computer components within data-processing system 400 or to and from other data-processing devices, components, computers, etc. The data-processing system 400 may be implemented in some embodiments as, for example, a server in a client-server based network (e.g., the Internet) or in the context of a client and a server (i.e., where aspects are practiced on the client and the server).

In some example embodiments, the data-processing system 400 may be, for example, a standalone desktop computer, a laptop computer, a Smartphone, a pad computing device, a networked computer server, and so on, wherein each such device can be operably connected to and/or in communication with a client-server based network or other types of networks (e.g., cellular networks, Wi-Fi, etc.). The data-processing system 400 can communicate with other devices or systems (e.g., the printing system 310). Communication between the data-processing system 400 and the printing system 310 can be bidirectional, as indicated by the double arrow 402. Such bidirectional communications may be facilitated by, for example, a computer network, including wireless bidirectional data communications networks.

FIG. 15 illustrates a computer software system 450 for directing the operation of the data-processing system 400 depicted in FIG. 14. Software application 454, stored for example in the memory 342 can generally include one or more modules, an example of which is module 452. The computer software system 450 also can include a kernel or operating system 451 and a shell or interface 453. One or more application programs, such as software application 454, may be “loaded” (i.e., transferred from, for example, mass storage or another memory location into the memory 342) for execution by the data-processing system 400. The data-processing system 400 can receive user commands and data through the interface 453; these inputs may then be acted upon by the data-processing system 400 in accordance with instructions from operating system 451 and/or software application 454. The interface 453 in some embodiments can serve to display results, whereupon a user 459 may supply additional inputs or can terminate a session. The software application 454 can include module(s) 452, which can, for example, implement instructions or operations such as those discussed herein. Module 452 may also be composed of a group of modules and/or sub-modules.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. A module may be composed of two parts: an interface, which lists the constants, data types, variable, and routines that can be accessed by other modules or routines, and an implementation, which may be private (e.g., accessible only to that module) and which can include source code that actually implements the routines in the module. The term module can also refer to an application, such as a computer program designed to assist in the performance of a specific task, such as word processing, accounting, inventory management, etc. A module may also refer to a physical hardware component or a combination of hardware and software. The previously discussed board game apparatus 100 is an example of a physical hardware component that can also operate according to instructions provided by a module such as module 452.

The module 452 may include instructions (e.g., steps or operations) for performing operations such as those discussed herein. For example, module 452 may include instructions for implementing the various operational steps of the disclosed board game apparatus 100.

Based on the foregoing, it can be appreciated that a number of different embodiments are disclosed herein. For example, in an embodiment, a board game apparatus for playing a game, can include a hexagonal game board comprising eleven rows and eleven columns forming a 6×6×6 grid of hexagonal cells, and at least two sets of game pieces, wherein each set of game pieces among the at least two sets of game pieces comprises a plurality of game pieces. Each game piece among the each set of game pieces can have a predefined mode of movement specific to a respective game piece type, allowing players of the hexagonal board game to maneuver game pieces across the hexagonal cells to capture enemy pieces and achieve a game-winning condition.

In an embodiment, the grid of hexagonal cells can comprise a 6×6×6 grid of the hexagonal cells.

In an embodiment, the plurality of game pieces of each set of game pieces can comprise the following game pieces: one King piece, one Queen piece, two Bishop pieces, two Knight pieces, two Rook pieces, and nine Pawn pieces.

In an embodiment of the board game apparatus, an objective of the game can involve placing a King piece of an opponent in the game in a game-winning condition, wherein the King piece is under a threat of capture and no legal move can reduce the threat.

In an embodiment of the board game apparatus, the King piece can be permitted to move one hexagonal cell among the grid of hexagonal cells in any of 12 directions: left, left diagonal up, left adjacent up, up, right adjacent up, right diagonal up, right, right diagonal down, right adjacent down, down, left adjacent down, and left diagonal down to an adjacent cell among the grid of hexagonal cells and either capture any enemy piece in the game occupying a destination cell, or move to an empty destination cell.

In an embodiment of the board game apparatus, King piece can be permitted to move two spaces sideways from a starting space toward a starting place of a selected Rook piece among the two Rook pieces and wherein the selected Rook piece is placed on a space skipped by the King piece.

In an embodiment of the board game apparatus, the Queen piece can be permitted to move any number of the hexagonal cells in any of 12 directions: left, left diagonal up, left adjacent up, up, right adjacent up, right diagonal up, right, right diagonal down, right adjacent down, down, left adjacent down, and left diagonal down along a continuous line of cells and capture any enemy piece in the game occupying a destination cell, or move to an empty destination cell among the hexagonal cells.

In an embodiment of the board game apparatus, a Bishop piece among the two Bishop pieces can be permitted to move any number of the hexagonal cells in any of 6 diagonal directions: left diagonal up, up, right diagonal up, right diagonal down, down, and left diagonal down along a continuous line of cells and capture any enemy piece in the game occupying a destination cell or move to an empty destination cell among the hexagonal cells.

In an embodiment of the board game apparatus, a Knight piece among the two Knight pieces can be permitted to move to any of the nearest hexagonal cells among the hexagonal cells that are not on the same row, column, or diagonal, forming an “L” shape, to capture any enemy piece occupying a destination cell, or move to an empty destination cell among the hexagonal cells.

In an embodiment of the board game apparatus, a Rook piece among the two Rook pieces can be permitted to move any number of the hexagonal cells in any of 6 adjacent directions: left, left adjacent up, right adjacent up, right, right adjacent down, and left adjacent down along a continuous line of cells, and capture any enemy piece occupying a destination cell, or move to an empty destination cell among the hexagonal cells.

In an embodiment of the board game apparatus, a Pawn piece among the nine Pawn pieces can be permitted to move forward to an adjacent unoccupied hexagonal cell among the hexagonal cells or capture an enemy piece in the game by moving to an adjacent hexagonal cell among the hexagonal cells diagonally in front, including an option for an initial two-cell move forward among the hexagonal cells, and subject to a promotion in the game to any piece, except a King piece, upon reaching a home row of an opponent in the game.

In an embodiment of the board game apparatus, the Queen piece and a Bishop piece among the two Bishop pieces can start the game with a Capture Immunity, which signifies that the Queen piece and the Bishop piece cannot be captured until at least one of the following conditions occurs: a player in the game uses a game turn to expressly disable the Capture Immunity of one game piece of an opponent; a movement of the Queen piece or the Bishop piece having Capture Immunity causes the Queen piece or the Bishop piece to lose the Capture Immunity; when a game piece is moved between a Queen pair or a Bishop pair, both Queens of the Queen pair or both Bishops of the Bishop pair lose existing Capture Immunity; or when a game piece having Capture Immunity is no longer under a threat of capture, the game piece loses Capture Immunity.

In an embodiment of the board game apparatus, the game can end in a draw under at least one of the following conditions: a player of the game has no legal move, and a King piece of the player is not in check, resulting in a stalemate; both players of the game agree to a draw; or fifty moves by each player of the game transpire without any captures or Pawn moves.

In an embodiment, a board game apparatus for playing a game, can include: a hexagonal game board comprising eleven rows and eleven columns forming a 6×6×6 grid of hexagonal cells; at least two sets of game pieces, wherein each set of game pieces among the at least two sets of game pieces comprises a plurality of game pieces; wherein each game piece among the each set of game pieces has a predefined mode of movement specific to a respective game piece type, allowing players of the hexagonal board game to maneuver game pieces across the hexagonal cells to capture enemy pieces and achieve a game-winning condition, wherein the grid of hexagonal cells comprises a 6×6×6 grid of the hexagonal cells, and wherein the plurality of game pieces of each set of game pieces comprises the following game pieces: one King piece, one Queen piece, two Bishop pieces, two Knight pieces, two Rook pieces, and nine Pawn pieces.

In an embodiment, a method for playing a board game using a board game apparatus, can involve: providing a hexagonal game board comprising eleven rows and eleven columns forming a 6×6×6 grid of hexagonal cells; providing at least two sets of game pieces, each set comprising a plurality of game pieces; assigning a predefined mode of movement to each game piece within each set of game pieces, wherein the predefined mode of movement is specific to a respective game piece type; and maneuvering the game pieces across the hexagonal cells in accordance with the predefined mode of movement to capture opposing game pieces and achieve a game-winning condition.

In an embodiment of the method, the grid of hexagonal cells can comprise a 6×6×6 grid of the hexagonal cells.

In an embodiment of the method, the plurality of game pieces of each set of game pieces can comprise the following game pieces: one King piece, one Queen piece, two Bishop pieces, two Knight pieces, two Rook pieces, and nine Pawn pieces.

In an embodiment of the method, an objective of the game can involve placing a King piece of an opponent in the game in a game-winning condition, wherein the King piece is under a threat of capture and no legal move can reduce the threat.

In an embodiment of the method, the King piece can be permitted to move one hexagonal cell among the grid of hexagonal cells in any of 12 directions: left, left diagonal up, left adjacent up, up, right adjacent up, right diagonal up, right, right diagonal down, right adjacent down, down, left adjacent down, and left diagonal down to an adjacent cell among the grid of hexagonal cells and either capture any enemy piece in the game occupying a destination cell, or move to an empty destination cell.

In an embodiment of the method, the King piece can be permitted to move two spaces sideways from a starting space toward a starting place of a selected Rook piece among the two Rook pieces and wherein the selected Rook piece is placed on a space skipped by the King piece.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A board game apparatus for playing a game, comprising:
a hexagonal game board comprising eleven rows and eleven columns forming a 6×6×6 grid of hexagonal cells;
at least two sets of game pieces, wherein each set of game pieces among the at least two sets of game pieces comprises a plurality of game pieces; and
wherein each game piece among the each set of game pieces has a predefined mode of movement specific to a respective game piece type, allowing players of the hexagonal board game to maneuver game pieces across the hexagonal cells to capture enemy pieces and achieve a game-winning condition.

2. The board game apparatus of claim 1 wherein the grid of hexagonal cells comprises a 6×6×6 grid of the hexagonal cells.

3. The board game apparatus of claim 1 wherein the plurality of game pieces of each set of game pieces comprises the following game pieces: one King piece, one Queen piece, two Bishop pieces, two Knight pieces, two Rook pieces, and nine Pawn pieces.

4. The board game apparatus of claim 3 wherein an objective of the game involves placing a King piece of an opponent in the game in a game-winning condition, wherein the King piece is under a threat of capture and no legal move can reduce the threat.

5. The board game apparatus of claim 3 wherein the King piece is permitted to move one hexagonal cell among the grid of hexagonal cells in any of 12 directions: left, left diagonal up, left adjacent up, up, right adjacent up, right diagonal up, right, right diagonal down, right adjacent down, down, left adjacent down, and left diagonal down to an adjacent cell among the grid of hexagonal cells and either capture any enemy piece in the game occupying a destination cell, or move to an empty destination cell.

6. The board game apparatus of claim 3 wherein the King piece is permitted to move two spaces sideways from a starting space toward a starting place of a selected Rook piece among the two Rook pieces and wherein the selected Rook piece is placed on a space skipped by the King piece.

7. The board game apparatus of claim 3 wherein the Queen piece is permitted to move any number of the hexagonal cells in any of 12 directions: left, left diagonal up, left adjacent up, up, right adjacent up, right diagonal up, right, right diagonal down, right adjacent down, down, left adjacent down, and left diagonal down along a continuous line of cells and capture any enemy piece in the game occupying a destination cell, or move to an empty destination cell among the hexagonal cells.

8. The board game apparatus of claim 3 wherein a Bishop piece among the two Bishop pieces is permitted to move any number of the hexagonal cells in any of 6 diagonal directions: left diagonal up, up, right diagonal up, right diagonal down, down, and left diagonal down along a continuous line of cells and capture any enemy piece in the game occupying a destination cell or move to an empty destination cell among the hexagonal cells.

9. The board game apparatus of claim 3 wherein a Knight piece among the two Knight pieces is permitted to move to any of the nearest hexagonal cells among the hexagonal cells that are not on the same row, column, or diagonal, forming an “L” shape, to capture any enemy piece occupying a destination cell, or move to an empty destination cell among the hexagonal cells.

10. The board game apparatus of claim 3 wherein a Rook piece among the two Rook pieces is permitted to move any number of the hexagonal cells in any of 6 adjacent directions: left, left adjacent up, right adjacent up, right, right adjacent down, and left adjacent down along a continuous line of cells, and capture any enemy piece occupying a destination cell, or move to an empty destination cell among the hexagonal cells.

11. The board game apparatus of claim 3 wherein a Pawn piece among the nine Pawn pieces is permitted to move forward to an adjacent unoccupied hexagonal cell among the hexagonal cells or capture an enemy piece in the game by moving to an adjacent hexagonal cell among the hexagonal cells diagonally in front, including an option for an initial two-cell move forward among the hexagonal cells, and subject to a promotion in the game to any piece, except a King piece, upon reaching a home row of an opponent in the game.

12. The board game apparatus of claim 3 wherein the Queen piece and a Bishop piece among the two Bishop pieces start the game with a Capture Immunity, which signifies that the Queen piece and the Bishop piece cannot be captured until at least one of the following conditions occur:
a player in the game uses a game turn to expressly disable the Capture Immunity of one game piece of an opponent;
a movement of the Queen piece or the Bishop piece having Capture Immunity causes the Queen piece or the Bishop piece to lose the Capture Immunity;
when a game piece is moved between a Queen pair or a Bishop pair, both Queens of the Queen pair or both Bishops of the Bishop pair lose existing Capture Immunity; or
when a game piece having Capture Immunity is no longer under a threat of capture, the game piece loses Capture Immunity.

13. The board game apparatus of claim 3 wherein the game ends in a draw under at least one of the following conditions:
a player of the game has no legal move, and a King piece of the player is not in check, resulting in a stalemate;
both players of the game agree to a draw; or
fifty moves by each player of the game transpire without any captures or Pawn moves.

14. A board game apparatus for playing a game, comprising:
a hexagonal game board comprising eleven rows and eleven columns forming a 6×6×6 grid of hexagonal cells;
at least two sets of game pieces, wherein each set of game pieces among the at least two sets of game pieces comprises a plurality of game pieces;
wherein each game piece among the each set of game pieces has a predefined mode of movement specific to a respective game piece type, allowing players of the hexagonal board game to maneuver game pieces across the hexagonal cells to capture enemy pieces and achieve a game-winning condition, wherein the grid of hexagonal cells comprises a 6×6×6 grid of the hexagonal cells, and wherein the plurality of game pieces of each set of game pieces comprises the following game pieces: one King piece, one Queen piece, two Bishop pieces, two Knight pieces, two Rook pieces, and nine Pawn pieces.

15. A method for playing a board game using a board game apparatus, the method comprising:
providing a hexagonal game board comprising eleven rows and eleven columns forming a 6×6×6 grid of hexagonal cells;
providing at least two sets of game pieces, each set comprising a plurality of game pieces;
assigning a predefined mode of movement to each game piece within each set of game pieces, wherein the predefined mode of movement is specific to a respective game piece type; and
maneuvering the game pieces across the hexagonal cells in accordance with the predefined mode of movement to capture opposing game pieces and achieve a game-winning condition.

16. The method of claim 15 wherein the grid of hexagonal cells comprises a 6×6×6 grid of the hexagonal cells.

17. The method of claim 15 wherein the plurality of game pieces of each set of game pieces comprises the following game pieces: one King piece, one Queen piece, two Bishop pieces, two Knight pieces, two Rook pieces, and nine Pawn pieces.

18. The method of claim 17 wherein an objective of the game involves placing a King piece of an opponent in the game in a game-winning condition, wherein the King piece is under a threat of capture and no legal move can reduce the threat.

19. The method of claim 17 wherein the King piece is permitted to move one hexagonal cell among the grid of hexagonal cells in any of 12 directions: left, left diagonal up, left adjacent up, up, right adjacent up, right diagonal up, right, right diagonal down, right adjacent down, down, left adjacent down, and left diagonal down to an adjacent cell among the grid of hexagonal cells and either capture any enemy piece in the game occupying a destination cell, or move to an empty destination cell.

20. The method of claim 17 wherein the King piece is permitted to move two spaces sideways from a starting space toward a starting place of a selected Rook piece among the two Rook pieces and wherein the selected Rook piece is placed on a space skipped by the King piece.
